(19) United States
(12) Patent Application Publication
(10) Pub. No.: US 2024/0157274 A1
(43) Pub. Date: May 16, 2024

(54) GAS-LIQUID SEPARATION DEVICE FOR AN EBULLATED BED REACTOR

(71) Applicant: CHEVRON U.S.A. INC., San Ramon, CA (US)

(72) Inventors: Steven Xuqi SONG, El Cerrito, CA (US); Blaine HOLMES, St. Albert (CA); Wayne MUNSTERMAN, Sherwood Park (CA); Tom BERRY, Sherwood Park (CA); Xiaohui ZHANG, Sherwood Park (CA); Deanne KELLY, Sherwood Park (CA); Ali VAKIL, Vancouver (CA); Ehsan ZAMAN, Coquitlam (CA); Marvin WEISS, Calgary (CA); Matthew D. POLAND, Oakland, CA (US); Brian HANSON, Martinez, CA (US)

(21) Appl. No.: 18/511,835

(22) Filed: Nov. 16, 2023

Related U.S. Application Data
(60) Provisional application No. 63/426,031, filed on Nov. 16, 2022.

(51) Int. Cl. B01D 19/00; B01L 5/02

(52) U.S. Cl. CPC B01D 19/0057; B01L 5/02; B01L 2300/0681; B01L 2400/0463

(57) ABSTRACT

A gas-liquid separator, adapted for separating liquid and gas in an ebullated bed reactor under operating conditions, is disclosed. The device may be used in the petroleum and chemical processing industries in catalytic reactions of hydrocarbonaceous feedstocks in the presence of hydrogen, at an elevated temperature and pressure, to separate gas and liquid from gas and liquid mixtures within the reactor. The device is generally vertically oriented and may be installed in the flow through pan of an ebullated bed reactor. The device comprises a transfer conduit for transferring a gas-liquid mixture stream from a lower section of an ebullated bed reactor to an upper section of the reactor, a vortex separation section having gas-rich and liquid-rich stream outlets, and a gas-rich stream outlet conduit located on top of and adjacent to the vortex separation section. The transfer conduit includes internal means to produce a spiral flow in the gas-liquid mixture, such as a helical or spiral insert. The vortex separation section is located at the top of the transfer conduit and includes separation means to separate the gas-liquid mixture stream into a liquid-rich stream and a gas-rich stream. A separator conduit extending from the top of the vortex separation section to the transfer conduit upper opening, aligned with and having substantially the same cross-sectional dimensions as the gas-rich stream outlet, may be used as the separation means. Among the benefits provided are improved efficiency of gas and liquid separation and reduced gas holdup within the reactor.

### CROSS-REFERENCE TO RELATED APPLICATIONS

This application claims the benefit of priority to U.S. Provisional Patent Appl. Ser. No. 63/426,031, filed on Nov. 16, 2022, entitled “GAS-LIQUID SEPARATION DEVICE FOR AN EBULLATED BED REACTOR”, the disclosure of which is herein incorporated by reference in its entirety.

### FIELD OF THE INVENTION

A gas-liquid separator for an ebullated bed hydroprocessing reactor is disclosed. The separator may be used in the petroleum and chemical processing industries in catalytic reactions of hydrocarbonaceous feedstocks in the presence of hydrogen, at an elevated temperature and pressure, to separate gas and liquid from gas and liquid mixtures.

### BACKGROUND OF THE INVENTION

Ebullated bed (EB) reactor hydroprocesses comprise passing concurrently flowing streams of liquids or slurries of liquids, solids, and gas through a vertically cylindrical vessel containing catalyst. The catalyst is placed in random motion in the liquid and has a gross volume dispersed through the liquid medium greater than the volume of the mass when stationary. EB technology has found commercial application in the upgrading of heavy liquid hydrocarbons or converting coal to synthetic oils. The process is generally described in U.S. Pat. No. 25,770 to Johanson. A number of other patent publications describe EB reactors and processes, as well as useful modifications, e.g., U.S. Pat. Nos. 4,221,653; 4,151,073; 4,354,852; 3,668,116; 4,012,314; 4,886,644; 5,066,467; 5,624,642; and 7,060,228. In general, a mixture of hydrocarbon liquid and hydrogen is passed upwardly through a bed of catalyst particles at a rate such that the particles are forced into random motion as the liquid and gas pass upwardly through the bed. The catalyst bed motion is controlled by a recycle liquid flow so that at steady state, the bulk of the catalyst does not rise above a defined level in the reactor. Vapors along with the liquid pass through the upper level of catalyst particles into a substantially catalyst free zone and are removed at the upper portion of the reactor.

The substantial amounts of hydrogen gas and light hydrocarbon vapors present in an operating ebullated bed rise through the reaction zone into the catalyst free zone. Liquid is both recycled to the bottom of the reactor and removed from the reactor as product from this catalyst free zone. Vapor is separated from the liquid recycle stream before being passed through the recycle conduit to the recycle pump suction. The recycle pump (ebullation pump) maintains the expansion (ebullation) and random motion of catalyst particles at a constant and stable level. Gases or vapors present in the recycled liquid materially decrease the capacity of the recycle pump as well as reduce the liquid residence time in the reactor and limit hydrogen partial pressure.

Reactors employed in a catalytic hydrogenation process with an ebullated bed of catalyst particles are designed with a central vertical recycle conduit downcomer to recycle liquid from the catalyst free zone above the ebullated catalyst bed to the suction of a recycle pump to recirculate the liquid through the catalytic reaction zone. The recycling of liquid from the upper portion of the reactor serves to ebullate the catalyst bed, maintain temperature uniformity through the reactor, and stabilize the catalyst bed.

EB reactor processes may experience a number of technical operating challenges. For example, if hydrogen and other gases are not substantially removed from the liquid recycle stream through the recycle pump, the recycled gases may reduce conversion by occupying reactor volume that otherwise would be occupied by the liquid feedstock. Hydrogen and other gases must therefore be separated from the recycle liquid prior to their reintroduction into the three-phase gas/liquid/catalyst reaction zone. As the catalyst in the three-phase zone is ebullated primarily by the upward flow of liquid stream, a recycle stream with high gas content will reduce the liquid velocity in the three-phase zone. The recycle pump thereby needs to operate at a higher rotational speed to maintain a constant expanded catalyst bed height. If the maximum pump speed is reached, there will not be enough liquid upward flow momentum to suspend the catalyst, potentially causing the catalyst to settle on the support grid. Hot spots may then develop in the settled catalyst bed creating safety concerns.

A continuing need therefore exists for improvements in ebullated bed reactor operation and design, including improved gas and liquid separation in ebullated bed reactors.

### SUMMARY OF THE INVENTION

The present invention is directed to a gas-liquid separation device (also referred to herein as a “separator”), adapted for separating gas and liquid in an ebullated bed reactor under operating conditions. The device provides effective separation of gas and liquid from a gas-liquid mixture when installed in the flow through pan of an ebullated bed reactor. The device provides effective separation of gas and liquid, while minimizing gas holdup in the reactor. The device is well-suited for retrofit applications and can be used for new reactor designs to achieve efficient gas and liquid separation so that ebullated bed reactor operational performance is improved. Among the benefits provided are improved efficiency of gas and liquid separation and reduced gas holdup within the reactor. While generally intended for use in an ebullated bed reactor, the device may also be used in other petroleum and chemical processing operations.

The gas-liquid separator device is generally vertically oriented within a reactor and may be typically installed in the flow through (recycle) pan of an ebullated bed reactor. The device comprises a transfer conduit for transferring a gas-liquid mixture stream from a lower section of the ebullated bed reactor to an upper section of the reactor, a vortex separation section having gas-rich and liquid-rich stream outlets and a top plate, and a gas-rich stream outlet conduit located on top of and adjacent to the vortex separation section. The transfer conduit includes internal means to produce a spiral flow in the gas-liquid mixture, such as a helical or spiral insert. The vortex separation section is located at the top of the transfer conduit and includes separation means to separate the gas-liquid mixture stream into a liquid-rich stream and a gas-rich stream. A separator conduit extending from the top of the vortex separation section to the transfer conduit upper opening, aligned with and having substantially the same cross-sectional dimensions as the gas-rich stream outlet, may be used as the separation means.

The invention also relates to a process for separating gas and liquid in a gas-liquid mixture. The process generally comprises passing a gas-liquid mixture vertically through a conduit having internal means to produce a vertical spiral flow in the gas-liquid mixture flowing through the conduit. The spiral flow gas-liquid mixture is then fed into a vortex separation section such that the spiral flow gas-liquid mixture contacts a separation conduit. The separation conduit is substantially aligned in parallel along its length to the vertical flow pathway of the spiral flow gas-liquid mixture. The spiral flow of the mixture leads to the liquid being predominantly located on the exterior of the spiral flow pathway while the interior of the spiral is predominantly gas. The separation conduit provides a separation of the liquid-rich stream flowing on the exterior of the separation conduit and the gas-rich stream flowing within the interior of the separation conduit. The liquid-rich stream is then passed to a liquid-rich stream outlet and the gas-rich stream is passed to a separate gas-rich stream outlet.

### BRIEF DESCRIPTION OF THE DRAWINGS

FIGS. 1-3 provide representative views of a gas-liquid separation device according to an embodiment of the invention and an installation in an ebullated bed reactor. The scope of the invention is not limited by these representative figures and is to be understood to be defined by the appended claims.

FIG. 1 depicts a side cross-sectional view of the separation device of the invention.

FIG. 2 depicts an isometric side view of the separation device of the invention.

FIG. 3 depicts the top section of an ebullated bed reactor with a plurality of separation devices installed on the flow through (recycle) pan according to the invention.

### DETAILED DESCRIPTION

Specific embodiments and benefits are apparent from the detailed description provided herein. It should be understood, however, that the detailed description, figures, and any specific examples, while indicating beneficial embodiments, including some that are preferred, are intended for purposes of illustration only and are not intended to limit the scope of the invention.

The invention is generally directed to a separation device (“separator”) for separating gas and liquid from a gas-liquid mixture. The separator is particularly adapted for use in hydroprocessing reactors, particularly in ebullated bed reactors. The device provides effective separation of gas and liquid from a gas-liquid mixture when installed in the flow through (recycle) pan of an ebullated bed reactor, while minimizing gas holdup in the reactor.

The separator comprises a transfer conduit, a vortex separation section having a separation conduit located therein and gas and liquid outlets, and a gas conduit to pass the gas from the separator to the exterior of the device. The transfer conduit includes internal means to produce a spiral flow in the gas-liquid mixture, such as a helical or spiral insert. The vortex separation section is located at the top of the transfer conduit and includes separation means to separate the gas-liquid mixture stream into a liquid-rich stream and a gas-rich stream. A separator conduit extending from the top of the vortex separation section to the transfer conduit upper opening, aligned with and having substantially the same cross-sectional dimensions as the gas-rich stream outlet, may be used as the separation means. The gas-rich stream outlet conduit is used to pass the gas-rich stream to the exterior of the device.

The transfer conduit may generally be of any cross-sectional shape provided the gas-liquid mixture flows vertically upward within the conduit. Convenient available conduit shapes, such as reactor grade piping are suitable and are preferably designed to allow suitable gas-liquid mixture flowrates and minimal pressure drop. Typical pipe diameter sizes in the range of about 2 to 8 in., or 4 to 6 in., or a diameter of about 5 in., may be used. The transfer conduit may comprise lower and upper sections, the lower and upper sections being open on both ends and configured to fit together at corresponding ends to form the conduit. In such cases, the upper section may comprise the internal means to produce a spiral flow in a gas-liquid mixture flowing through the conduit, with the lower section being configured to allow a gas-liquid mixture to flow into the lower opening and pass through the lower section into the lower end of the conduit upper section. In general, the internal means to produce a spiral flow in a liquid and gas mixture may be a spiral or helical insert having a length substantially the same as the length of the transfer conduit upper section, wherein the insert is positioned within the transfer conduit upper section from the top to the bottom of the upper section and has substantially the same dimensions as the interior cross-section of the transfer conduit. Other structures or inserts that produce a spiral gas-liquid flow through the transfer conduit may also be used. When the separator is installed in the flow through pan of an ebullated bed reactor, the transfer conduit lower section will typically be adapted to fit in corresponding openings in the flow-through pan so that a gas-liquid mixture can be passed from the lower section of the reactor into the separation device.

The vortex separation section is open on the bottom and has a cross-sectional area and dimensions that are larger than the transfer conduit so that it can fit over the upper part of the transfer conduit. As such, the vortex separation section may be positioned over the top (upper section) of the transfer conduit to extend below the top of the transfer conduit. Typically, the vortex separation section is sized to provide a liquid flow pathway between the exterior of the transfer conduit and the overlapping interior of the vortex separation section. When installed in an ebullated bed reactor flow through pan, a separator having a round vortex separation section and transfer conduit produces an annular liquid flow pathway between the exterior of the transfer conduit and the interior of the separation section. The vortex separation section may typically be substantially round or a pipe section having a diameter in the range of about 4 to 12 in., or 6 to 10 in., or 6 to 9 in., or 7 to 9 in., or a diameter of about 8 in. The term “substantially” in this context is intended to mean any normal variation in a dimension that would be expected by the skilled person.

The internal separation means for separating the gas-liquid mixture stream into a liquid-rich stream and a gas-rich stream within the vortex separation section generally utilizes the separation of liquid and gas created within the vortex to separate the two phases into a liquid-rich stream and a gas-rich stream. Each stream is directed to the corresponding gas or liquid-rich stream outlet. In some cases, the gas-rich stream outlet may be located at the top of the vortex separation section, e.g., the outlet may be an opening in the top plate. The internal separation means may then comprise, e.g., a separator conduit extending from the top of the vortex separation section to the transfer conduit upper opening. In such cases, the separator conduit may be aligned with and have substantially the same cross-sectional dimensions as the gas-rich stream outlet present in the top plate.

A top plate is also present on the vortex separation section. In cases where the gas-rich stream flows vertically through the top of the vortex separation section, the top plate will have a gas-rich stream outlet sized to allow the flow of the gas-rich stream to pass from the vortex separation section into the gas-rich stream outlet conduit. The separation means, such as a conduit or pipe section, will typically be in alignment with the gas-rich stream outlet in the top plate to allow gas separated within the vortex separation section to flow into the gas-rich stream outlet conduit. The gas-rich stream outlet and a conduit used as the separations means will typically have substantially the same cross sectional dimensions, or in the case of a pipe, the same diameter. The separator conduit will typically have a smaller cross-sectional area and dimensions than the cross-sectional area and dimensions of the transfer conduit. The internal separation means may typically be substantially round or a pipe section having a diameter in the range of about 1 to 6 in., or 1 to 4 in., or 1 to 3 in., or 2 to 3 in., or a diameter of about 2.5 in. The term “substantially” in this context is intended to mean any normal variation in a dimension that would be expected by the skilled person.

The gas-rich stream outlet conduit generally has a larger cross-sectional area or diameter than the separator conduit, and a smaller cross-sectional area or diameter than the vortex separation section. The outlet conduit may be angled to direct gas flow in a desired direction. In the case of an ebullated bed reactor installation, the outlet conduit may be an elbow, typically having an angular orientation of about 30 to 60 degrees from horizontal. In a flow through pan installation, the outlet flow direction may also be oriented relative to the perimeter of the pan, e.g., an outlet elbow may be oriented at an angle of about 15 to 60 degrees from the radial orientation of the separation device relative to the center of a reactor.

In general, the transfer conduit, the internal spiral flow means, the vortex separation section, the internal separation means, the gas-rich stream outlet, and the gas-rich stream outlet conduit may all be centrally aligned about the same vertical axis. In the case of installation on the flow through pan of an ebullated bed reactor, such an arrangement produces a substantially vertical flow pathway through the device up to the separation means. The gas-rich stream continues vertically upward and exits the device through the gas-rich stream outlet conduit. The liquid-rich stream is diverted to the liquid outlet in a downward direction and flows onto the pan and downward through the downcomer.

Various support structures may be used to support the separation device when installed in a reactor or when used in another application. For example, when installed in the flow through pan of an ebullated bed reactor, the lower section opening of the transfer conduit may be welded or otherwise supported on the flow through pan, e.g., by braces mounted within the reactor.

The invention further relates to the use of the separation device in any application that may require the separation of gas and liquid from a gas-liquid mixture, as well as any apparatus having the separation device installed therein, such as a flow through (recycle) pan, or an ebullated bed reactor.

The invention further relates to a process for separating gas and liquid in a gas-liquid mixture. The process generally comprises passing a gas-liquid mixture vertically through a conduit having internal means to produce a vertical spiral flow in the gas-liquid mixture flowing vertically through the conduit; passing the spiral flow gas-liquid mixture into a vortex separation section, wherein the spiral flow gas-liquid mixture contacts a separation conduit that is substantially aligned in parallel along its length to the vertical flow pathway of the spiral flow gas-liquid mixture, thereby forming a liquid-rich stream on the exterior of the separation conduit and a gas-rich stream on the interior of the separation conduit; and passing the liquid-rich stream to a liquid-rich stream outlet and the gas-rich stream to a separate gas-rich stream outlet. The process may be used with one or more separators as described herein to separate the gas and liquid from the gas-liquid mixture, in particular in flow through pan and ebullated bed reactors applications.

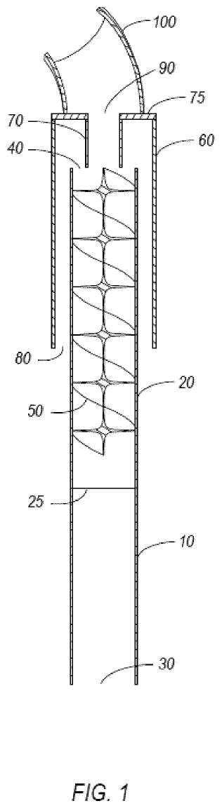

In embodiments of the invention, as represented by FIGS. 1 to 3, a separation device may have a cross-sectional view as shown in FIG. 1. The transfer conduit may comprise transfer conduit lower section 10 and transfer conduit upper section 20, with lower and upper section junction 25. The transfer conduit comprises lower opening outlet 30 and upper opening outlet 40. Internal separation means, such as spiral insert 50, is shown in the upper section. Vortex separation section 60 is shown comprising internal separation conduit 70, top plate 75, liquid-rich stream outlet 80, and gas-rich stream outlet 90. Gas-rich stream outlet conduit 100 is shown having an angular orientation relative to horizontal of about 45 degrees and an outlet elbow orientation of about 30 degrees from the radial orientation of the separation device relative to the center of a reactor.

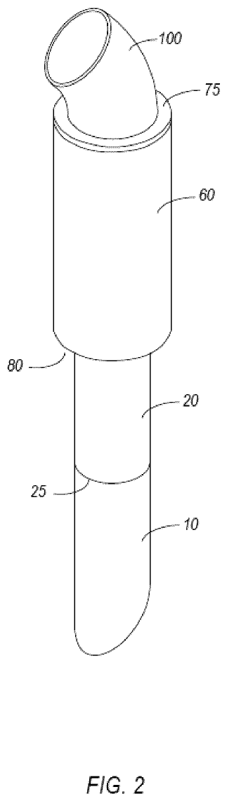

FIG. 2 shows an isometric view of the separation device exterior. As shown, the separation device includes the same transfer conduit configuration of FIG. 1 comprising transfer conduit lower section 10 and transfer conduit upper section 20, along with lower and upper section junction 25. Also included in FIG. 2 for illustration purposes are vortex separation section 60, top plate 75, liquid-rich outlet opening 80 (located at the annular region between the vortex separation section and the exterior of the transfer conduit), and gas-rich stream outlet conduit 100. While FIG's. 1 and 2 show one embodiment of a possible device configuration, other configurations may be used.

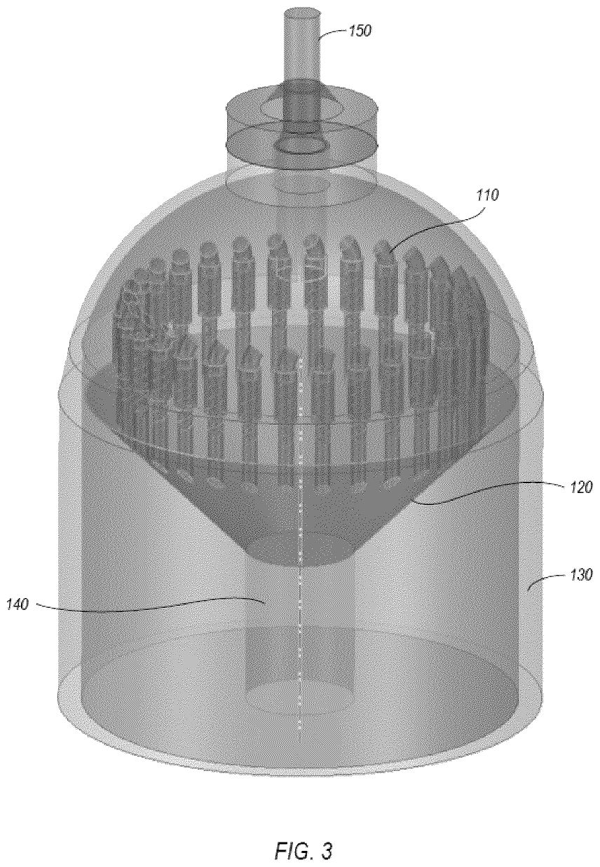

FIG. 3 shows an embodiment of the invention with multiple separation devices 110 installed in the flow through pan 120 in the top section of an ebullated bed reactor 130. Downcomer 140 and reactor effluent outlet 150 are also shown.

The separation device of the invention, and associated aspects, including the specific embodiments described herein, provides certain benefits and improvements in hydroprocessing applications, including improved gas and liquid separation and, in ebullated bed installations, reduced gas entrainment in the downcomer liquid stream.

The foregoing description of one or more embodiments of the invention is primarily for illustrative purposes, it being recognized that many variations might be used that would still incorporate the essence of the invention. Reference should be made to the following claims in determining the scope of the invention.

All patents and publications cited in the foregoing description of the invention are incorporated herein by reference.

What is claimed is:

1. A gas-liquid separator, adapted for separating liquid and gas in an ebullated bed reactor under operating conditions, the separation device comprising:
a transfer conduit for transferring a gas-liquid mixture stream from a lower section of an ebullated bed reactor to an upper section of the reactor, wherein the conduit is oriented vertically during operation in the reactor, the conduit having a lower opening and an upper opening, and comprising internal means to produce a spiral flow in a liquid and gas mixture flowing vertically through the conduit;
a vortex separation section, located on top of and adjacent to the upper opening of the transfer conduit, the vortex separation section comprising internal separation means for separating the gas-liquid mixture stream into a liquid-rich stream and a gas-rich stream, a top plate, an outlet for the liquid-rich stream, and an outlet for the gas-rich stream; and
a gas-rich stream outlet conduit located on top of and adjacent to the vortex separation section and in fluid communication with the gas-rich stream outlet of the vortex separation section.

2. The separator of claim 1, wherein the transfer conduit comprises lower and upper sections, the lower and upper sections being open on both ends and configured to fit together at corresponding ends to form the conduit, the upper section comprising the internal means to produce a spiral flow in a gas-liquid mixture flowing through the conduit and the lower section being configured to allow a gas-liquid mixture to flow into the lower opening and pass through the lower section into the lower end of the conduit upper section.

3. The separator of claim 2, wherein the transfer conduit lower section is adapted to fit in corresponding openings in a flow-through pan of an ebullated bed reactor so that a gas-liquid mixture can be passed from the lower section of the reactor into the separation device.

4. The separator of claim 2, wherein the upper and lower sections of the transfer conduit are substantially round or pipe sections having diameters in the range of about 2 to 8 inches.

5. The separator of claim 2, wherein the internal means to produce a spiral flow in a liquid and gas mixture is a spiral or helical insert having a length substantially the same as the length of the transfer conduit upper section, wherein the insert is positioned within the transfer conduit upper section from the top to the bottom of the upper section and has substantially the same dimensions as the interior cross-section of the transfer conduit.

6. The separator of claim 1, wherein the vortex separation section is open on the bottom, has a cross-sectional area and dimensions that are larger than the transfer conduit, is positioned over the top of the transfer conduit and extends below the top of the transfer conduit.

7. The separator of claim 6, wherein the vortex separation section is sized to provide a liquid flow pathway between the exterior of the conduit and the interior of the vortex separation section.

8. The separator of claim 1, wherein the vortex separation section is substantially round or a pipe section having a diameter in the range of about 4 to 12 inches.

9. The separator of claim 7, wherein the liquid-rich stream outlet comprises the liquid flow pathway.

10. The separator of claim 1, wherein the gas-rich stream outlet is located at the top of the vortex separation section.

11. The separator of claim 1, wherein the internal separation means comprises a separator conduit extending from the top of the vortex separation section to the transfer conduit upper opening, the separator conduit being aligned with and having substantially the same cross-sectional dimensions as the gas-rich stream outlet.

12. The separator of claim 1, wherein the internal separation means comprises a separator conduit having a smaller cross-sectional area and dimensions than the cross-sectional area and dimensions of the transfer conduit.

13. The separator of claim 1, wherein the internal separation means is substantially round or a pipe section having a diameter in the range of about 1 to 6 inches.

14. The separator of claim 1, wherein the transfer conduit, the internal spiral flow means, the vortex separation section, the internal separation means, the gas-rich stream outlet, and the gas-rich stream outlet conduit are centrally aligned about the same vertical axis.

15. A flow through pan gas-liquid separator for an ebullated bed reactor comprising a plurality of separators according to claim 1.

16. An ebullated bed reactor comprising the flow through pan gas-liquid separator of claim 15.

17. A process for separating gas and liquid in a gas-liquid mixture, the process comprising passing a gas-liquid mixture vertically through a conduit having internal means to produce a vertical spiral flow in the gas-liquid mixture flowing vertically through the conduit; passing the spiral flow gas-liquid mixture into a vortex separation section, wherein the spiral flow gas-liquid mixture contacts a separation conduit that is substantially aligned in parallel along its length to the vertical flow pathway of the spiral flow gas-liquid mixture, thereby forming a liquid-rich stream on the exterior of the separation conduit and a gas-rich stream on the interior of the separation conduit; and passing the liquid-rich stream to a liquid-rich stream outlet and the gas-rich stream to a separate gas-rich stream outlet.

18. The process of claim 17, wherein a plurality of separators is used to separate the gas and liquid from the gas-liquid mixture.

19. The process of claim 18, wherein the process is conducted using a flow through pan gas-liquid separator.

20. The process of claim 18, wherein the process is conducted within an ebullated bed reactor.
